(19) United States
(12) Patent Application Publication
(10) Pub. No.: US 2009/0027324 A1
(43) Pub. Date: Jan. 29, 2009

(54) Liquid Crystal Display With Wide Viewing Angle

(76) Inventors: Wen-Hao Hsu, Hsin-Chu (TW); Ting-Wei Su, Hsin-Chu (TW); Jenn-Jia Su, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 11/868,966

(22) Filed: Oct. 9, 2007

(30) Foreign Application Priority Data
Jul. 26, 2007 (TW) 096127319

(51) Int. Cl. G09G 3/36

(52) U.S. Cl. 345/92; 345/90

(57) ABSTRACT

A LCD with wide viewing angle includes a gate driving circuit, a data driving circuit, and a plurality of pixels. Each pixel includes two sub-pixels. The data driving circuit includes a plurality of data lines for transmitting a plurality of data driving signals to the pixels for display. The gate driving circuit includes a plurality of gate lines and common lines. The pluralities of gate lines sequentially transmit gate driving signals to the corresponding pixels. The pluralities of common lines sequentially transmit common driving signals to the corresponding pixels according to the gate driving signals.

### BACKGROUND OF THE INVENTION

1. Field of the Invention

The present invention relates to a liquid crystal display (LCD) with wide viewing angle, and more particularly, to an LCD utilizing different common voltages to drive pixels for achieving the wide viewing angle characteristic.

2. Description of the Related Art

A conventional LCD comprises a pixel in a pixel unit. Due to this structure, the brightness will be different when observing from different viewing angles. Consequently, the viewing angle of the conventional LCD is limited. FIG. 1 is a diagram illustrating a pixel P₁₁ of a general LCD with a wide viewing angle. The pixel P11 comprises a sub-pixel SP₁₁₁ and SP₁₁₂. When the pixel P₁₁ receives the data driving signal V_{S1}, the sub-pixels SP₁₁₁ and SP₁₁₂ generates different brightness. In this way, when the LCD composed of the pixels such as the pixel P₁₁ is observed, the viewing angle can be improved.

As shown in FIG. 1, the sub-pixel SP₁₁₁ comprises a switch SW₁, a liquid crystal capacitor C_{LC1}, and a storage capacitor C_{ST1}. The switch SW₁ is coupled to the gate line G₁ and data line S₁ corresponding to the pixel P₁₁ for receiving the data driving signal V_{S1} and the gate driving signal V_{G1}. When the switch SW₁ receives the gate driving signal V_{G1}, the switch SW₁ is turned on and the data driving signal V_{S1} is transmitted to the liquid crystal C_{LC1} and the storage capacitor C_{ST1}. One end of the crystal capacitor C_{LC1} is coupled to one end of the switch SW₁, and the other end of the crystal capacitor C_{LC1} is coupled to the upper substrate. The liquid crystal of the sub-pixel SP₁₁₁ rotates according to the liquid crystal driving voltage V_{LC1} across the liquid crystal capacitor C_{LC1} for generating brightness. The storage capacitor C_{ST1} is coupled between one end of the switch SW₁ and the common end CS₁ (the voltage of the common end CS₁ is V_{CS1}) corresponding to the sub-pixel SP₁₁₁ for storing the liquid crystal driving voltage V_{LC1} and for keeping the same rotation of the liquid crystal. The switch SW₂ is coupled to the gate line G₁ and data line S₁ corresponding to the pixel P₁₁ for receiving the data driving signal V_{S1} and the gate driving signal V_{G1}. When the switch SW2 receives the gate driving signal V_{G1}, the switch SW₂ is turned on and the data driving signal V_{S1} is transmitted to the liquid crystal C_{LC2} and the storage capacitor C_{ST2}. One end of the crystal capacitor C_{LC2} is coupled to one end of the switch SW₂, and the other end of the crystal capacitor C_{LC2} is coupled to the upper substrate. The liquid crystal of the sub-pixel SP₁₁₂ rotates according to the liquid crystal driving voltage V_{LC2} across the liquid crystal capacitor C_{LC2} for generating brightness. The storage capacitor C_{ST2} is coupled between one end of the switch SW₂ and the common end CS₂ (the voltage of the common end CS₂ is VCS₂) corresponding to the sub-pixel SP₁₁₂ for storing the liquid crystal driving voltage V_{LC2} and keeping the same rotation of the liquid crystal. When the liquid crystal driving voltages V_{CS1} and V_{CS2} change differently, the liquid crystal driving voltage V_{LC1} and the liquid crystal driving voltage V_{LC2} are different, and thus the rotations of the liquid crystal of the sub-pixels SP₁₁₁ and SP₁₁₂ become different. In this way, the brightness of the sub-pixel SP₁₁₁ is different from the brightness of the sub-pixel SP₁₁₂ and therefore the wide viewing angle characteristic is achieved.

In the prior art, the common ends corresponding to the sub-pixels of the pixels of the same row are not entirely independent. Instead, the common ends are shorted in groups at the outer peripheral wires. Therefore, the conventional driving method of switching the voltages of the common ends causes higher power consumption, lower coupling rate of the capacitors, and light leakage of the black frame because the conventional method requires switching the voltages of the common ends with high frequency. Furthermore, the design of outer peripheral wires of the prior art is complicated so that the size of the margin of the LCD cannot be efficiently reduced. And when the size of the LCD becomes larger, which means the scanning period will be reduced, the LCD suffers uneven display problems due to the RC delay.

### SUMMARY OF THE INVENTION

The present invention provides an LCD with wide viewing angle. The LCD has an upper substrate, a lower substrate disposed opposite to the upper substrate, and a liquid crystal layer disposed between the upper and the lower substrates. The LCD comprises a gate driving circuit comprising a plurality of gate lines for sequentially transmitting a plurality of gate driving signals; a plurality of first common lines, a voltage of each first common line changed with a low frequency close to frame rate of the LCD according to the gate driving signal of the corresponding gate line; and a plurality of second common ends, a voltage of each second common end changed with the low frequency close to the frame rate of the LCD according to the gate driving signal of the corresponding gate line; a data driving circuit comprising a plurality of data lines for transmitting a plurality of data for display; and a plurality of pixels, each pixel comprising a first sub-pixel coupled to the gate line, the data line, and the first common end corresponding to the pixel for display brightness according to the corresponding gate driving signal, the voltage of the corresponding first common end, and the corresponding data; and a second sub-pixel coupled to the gate line, the data line, and the second common end corresponding to the pixel for display brightness according to the corresponding gate driving signal, the voltage of the corresponding second common end, and the corresponding data.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a pixel of a conventional LCD with wide viewing angle.

FIG. 2 is a diagram illustrating an LCD with wide viewing angle of the present invention.

FIG. 3 is a diagram illustrating the sub-pixels driven according to a first embodiment of the present invention.

FIG. 4 is a diagram illustrating the sub-pixels driven according to a second embodiment of the present invention.

FIG. 5 is a diagram illustrating the gate driving circuit of the present invention driving the entire LCD.

FIG. 6 is a diagram illustrating the gate driving circuit of the present invention driving the entire LCD.

### DETAILED DESCRIPTION

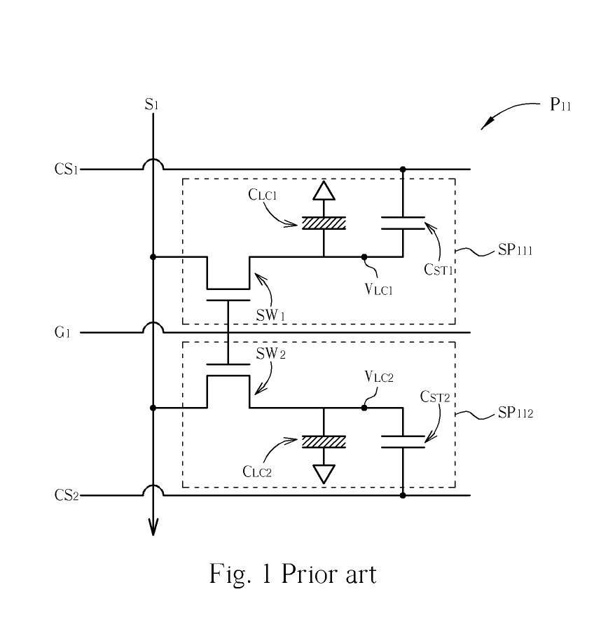

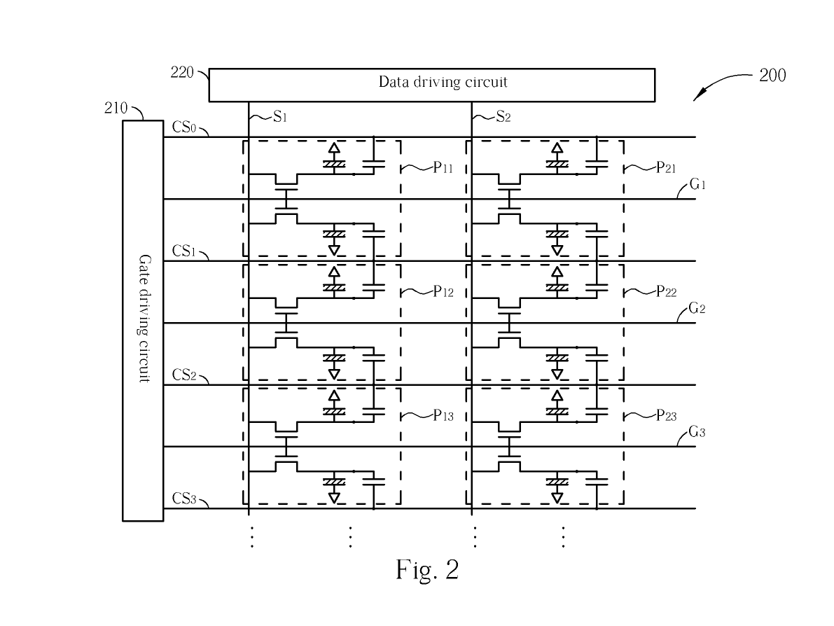

FIG. 2 is a diagram illustrating an LCD with wide viewing angle according to the present invention. The LCD 200 comprises a gate driving circuit 210, a data driving circuit 220, and a plurality of pixels P₁₁, P₁₂, P₁₃, P₂₁, P₂₂, P₂₃, and so on. Each of the pixels in FIG. 2 has the same structure as described in FIG. 1 and thus the related description is omitted. The data driving circuit 220 comprises a plurality of data lines S₁, S₂ . . . for transmitting a plurality of data driving signals V_{S1}, V_{S2} . . . to the corresponding pixels for display. The gate driving circuit 210 comprises a plurality of gate lines G₁, G₂, G₃ . . . and a plurality of common ends CS₁, CS₂, CS₃ . . . The plurality of gate lines G₁, G₂, G₃ . . . are disposed for sequentially transmitting a plurality of gate driving signals V_{G1}, V_{G2}, V_{G3} . . . to the corresponding pixels P₁₁, P₂₁ . . . . The plurality of common ends CS₁, CS₂, CS₃ . . . are disposed for respectively transmitting common end driving signals V_{CS1}, V_{CS2}, V_{CS3} . . . according to the corresponding gate driving signals. Each common end driving signal is different from the others. Thus, the sub-pixels of the same pixel display different brightnesses because of the different corresponding common driving signals. In this way, the wide viewing angle characteristic is achieved. In the LCD 200 of the present invention, one common end is only utilized by pixels of one row. For example, in the LCD 200, M gate lines are provided corresponding to pixels of M rows so that M common ends are provided accordingly. The advantage of the present invention is that the method of the present invention driving common ends can be performed in low frequencies (for example, 60 Hz or 120 Hz, which is close to the frame rate of the display), and thus the RC delay effect is reduced, the capacitor coupling rate is raised, and the peripheral wirings and space are saved.

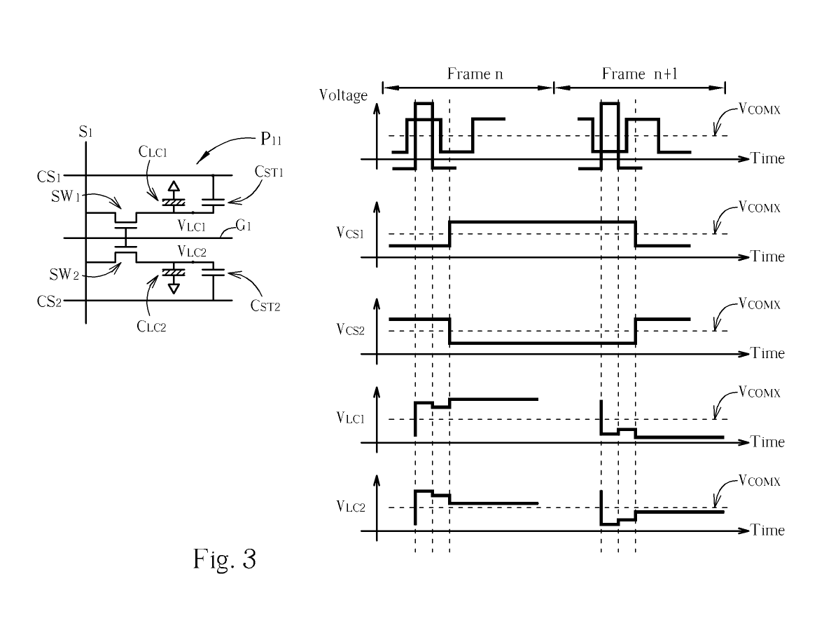

FIG. 3 is a diagram illustrating the sub-pixels SP₁₁₁ and SP₁₁₂ driven according to a first embodiment of the present invention. In FIG. 3, pixel P₁₁ is only an example. The crystal capacitor C_{LC1} of the sub-pixel SP₁₁₁ is charged to the data driving signal V_{S1} after the switch SW₁ is turned on by the gate driving signal V_{G1}. In the following, the voltage V_{CS1} of the common end CS₁ is pulled up. Hence, through the coupling of the capacitor C_{ST1}, the voltage stored in the C_{LC1} is pulled up and higher than the original voltage V_{S1}. On the other hand, the crystal capacitor C_{LC2} of the sub-pixel SP₁₁₂ is charged to the data driving signal V_{S1} after the switch SW₂ is turned on by the gate driving signal V_{G2}. Then the voltage V_{CS2} of the common end CS₂ is pulled down. Hence, through the coupling of the capacitor C_{ST2}, the voltage which is stored in the capacitor C_{LC2} is pulled down to a voltage lower than the original voltage V_{S1}. Consequently, the difference between the liquid crystal driving voltages V_{LC1} and V_{LC2} is generated, inducing the rotation difference between the corresponding liquid crystals. In fact, the voltage V_{CS1} can be changed in the same direction as the change of voltage V_{CS1}, but need not be; generally, the change of the voltage V_{CS1} is an inverse to the change of the voltage V_{CS2}. As long as the change of the voltage V_{CS1} is different from the change of the voltage V_{CS2}, the liquid crystal driving voltages V_{LC1} and V_{LC2} are different.

In other words, the voltage of the common end is kept constant regularly and changed for an appropriate period (after the switch is turned off) of each frame. The different liquid crystal driving signals are generated in the above way, and the wide viewing angle characteristic is achieved.

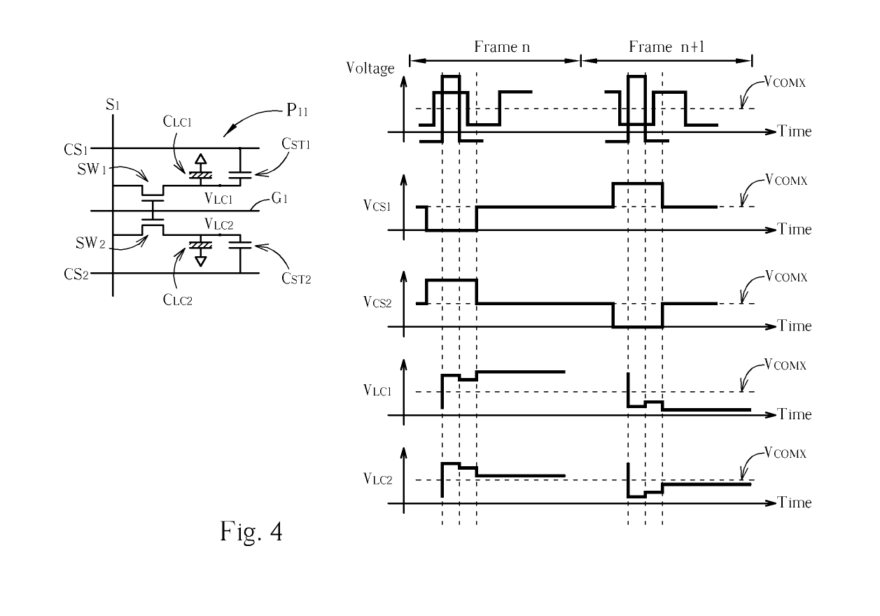

FIG. 4 is a diagram illustrating the sub-pixels SP₁₁₁ and SP₁₁₂ driven according to a second embodiment of the present invention. The difference between FIG. 3 and FIG. 4 is that in FIG. 4, the voltage V_{CS1} of the common end CS₁ and the voltage VCS₂ of the common end CS₂ are the same as the voltage V_{COMX} of the upper substrate most of the time. That is, the voltage of the common end of this embodiment is kept the same as the voltage V_{COMX} and changed after the corresponding switch is turned off. Therefore, normally, there is no voltage difference generated between the upper substrate and the lower substrate of the LCD, which reduces the light leakage (especially when displaying dark frames), raises the contrast, and raises the open ratio with other pixel layout techniques.

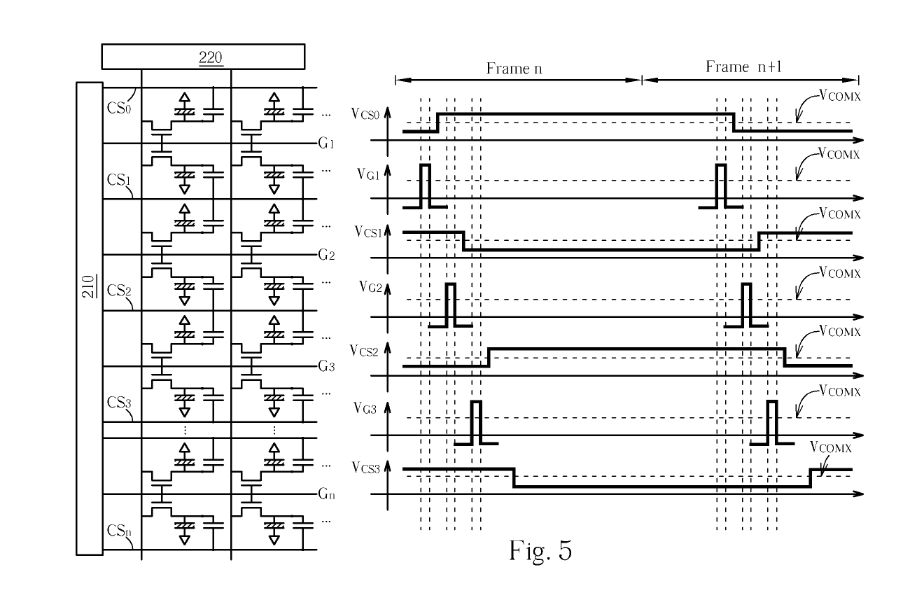

FIG. 5 is a diagram illustrating the gate driving circuit of the present invention driving the entire LCD. The present invention adopts independent storage capacitors for driving common end signals. In the gate driving circuit, each common end is driven by an independent circuit. In order to enable one liquid crystal driving signal of one pixel to be brighter than the other liquid crystal driving signal of the same pixel, the common end driving signals of the adjacent common ends are inversed. In fact, in the gate driving circuit 210, the common end driving signals can be realized with shift registers, which can be arranged with the shift registers generating gate driving signals. In this way, one common end driving signal can be generated according to a corresponding gate driving signal.

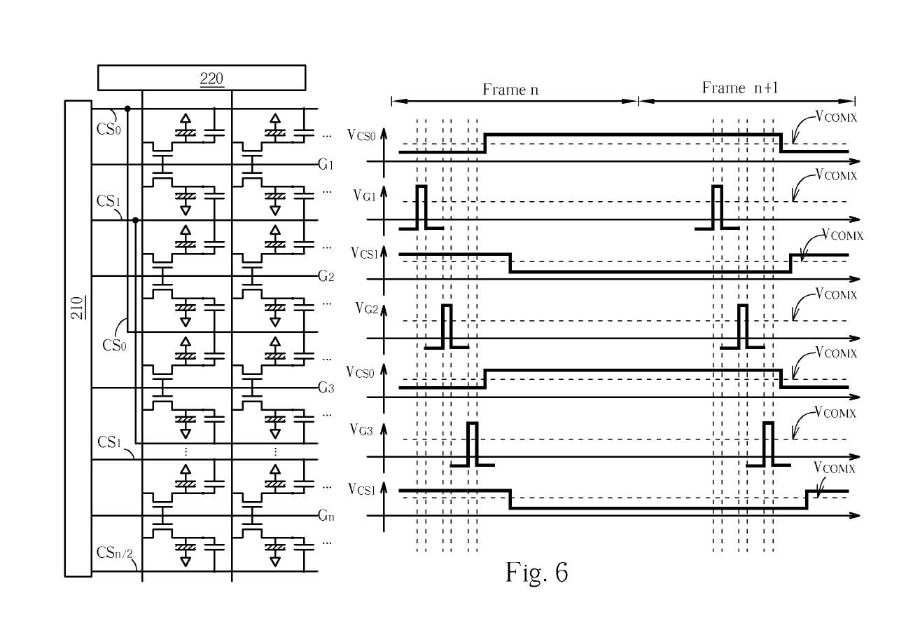

FIG. 6 is a diagram illustrating the gate driving circuit of the present invention driving the entire LCD. FIG. 6 is similar to FIG. 5 and the difference is that in FIG. 6, a part of the common ends are coupled for reducing the amount of the storage capacitors. In FIG. 6, the common end CS₀ is composed of two wires coupled to the pixels of the 1^{st} row and the 4^{th} row for providing the common end driving signal V_{CS0} to the pixels of the 1^{st} row and the 4^{th} row, respectively. The common end CS₁ is composed of two wires coupled to the pixels of the 2^{nd} row and the 6^{th} row for providing the common end driving signal V_{CS1} to the pixels of the 2^{nd} row and the 6^{th} row, respectively. Then, the voltages V_{CS0} and V_{CS1} are inversely changed in the later timing after the gate driving signals V_{G1} and V_{G2}. This embodiment does not affect the evenness of the LCD and reduces the number of common ends of the gate driving circuit 210. Thus, the design complexity is lowered.

Those skilled in the art will readily observe that numerous modifications and alterations of the present invention may be made.

What is claimed is:

1. A liquid crystal display (LCD) with wide viewing angle, comprising:
an upper substrate;
a lower substrate disposed opposite to the upper substrate;
a liquid crystal layer disposed between the upper and the lower substrates;
a gate driving circuit comprising:
a plurality of gate lines for sequentially transmitting a plurality of gate driving signals;
a plurality of first common lines, a voltage of each first common line being changed with a low frequency close to a frame rate of the LCD according to the gate driving signal of the corresponding gate line; and
a plurality of second common ends, a voltage of each second common end being changed with the low frequency close to the frame rate of the LCD according to the gate driving signal of the corresponding gate line;
a data driving circuit comprising a plurality of data lines for transmitting a plurality of data for display; and
a plurality of pixels, each pixel comprising:
a first sub-pixel, coupled to the gate line, the data line, and the first common end corresponding to the pixel, for displaying image according to the corresponding gate driving signal, the voltage of the corresponding first common end, and the corresponding data; and
a second sub-pixel, coupled to the gate line, the data line, and the second common end corresponding to the pixel, for displaying brightness according to the corresponding gate driving signal, the voltage of the corresponding second common end, and the corresponding data.

2. The LCD of claim 1, wherein the first sub-pixel of each pixel comprises:
a first thin film transistor (TFT), comprising:
a gate end coupled to the gate line corresponding to the pixel;
a first end coupled to the data line corresponding to the pixel; and
a second end for coupling to the first end of the first TFT according to the gate driving signal received by the gate end of the first TFT;
a first liquid crystal capacitor coupled between the second end of the first TFT and the upper substrate; and
a first storage capacitor coupled between the second end of the first TFT and the first common end.

3. The LCD of claim 2, wherein the second sub-pixel of each pixel comprises:
a second TFT, comprising:
a gate end coupled to the gate line corresponding to the pixel;
a first end coupled to the data line corresponding to the pixel; and
a second end for coupling to the first end of the second TFT according to the gate driving signal received by the gate end of the second TFT;
a second liquid crystal capacitor coupled between the second end of the second TFT and the upper substrate; and
a second storage capacitor coupled between the second end of the second TFT and the second common end.

4. The LCD of claim 1, wherein when the gate driving circuit transmits a gate driving signal, the voltages of the corresponding first common end and the second common end remain constant.

5. The LCD of claim 1, wherein after the gate driving circuit transmits a gate driving signal, the voltage of the corresponding first common end is adjusted to a first voltage level in a predetermined period, and the voltage of the corresponding second common end is adjusted to a second voltage level in the predetermined period.

6. The LCD of claim 5, wherein the first voltage is a high voltage and the second voltage is a low voltage.

7. The LCD of claim 1, wherein the predetermined period is equal to a period between two consecutive gate driving signals of the corresponding gate line or less than the period between two consecutive gate driving signals of the corresponding gate line.

8. The LCD of claim 1, wherein the number of the plurality of the gate lines, the number of the plurality of the first common ends, and the number of the plurality of the second ends are substantially the same.
